(19) United States
(12) Patent Application Publication
(10) Pub. No.: US 2006/0124406 A1
(43) Pub. Date: Jun. 15, 2006

(54) Disk brake comprising an electromotively actuated adjusting device, and control method

(75) Inventor: Johann Baumgartner, Moosburg (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 10/537,272

(22) PCT Filed: Nov. 28, 2003
(86) PCT No.: PCT/EP03/13419

§ 371 Date: Oct. 20, 2005

(30) Foreign Application Priority Data
Dec. 2, 2002 (DE) 102 56 426.4

(51) Int. Cl. F16D 55/02

(52) U.S. Cl. 188/71.8

(57) ABSTRACT

A pneumatically actuated disc brake includes a caliper that straddles a brake disc, at least one brake application device, and at least one adjusting device, which is provided with an electromotive drive unit. The disc brake and a control method therefore are characterized by the fact that the at least one electromotively driven adjusting device is also used as a parking brake and/or emergency brake.

### BACKGROUND AND SUMMARY OF THE INVENTION

The invention relates to a disc brake and a method of controlling a disc brake having a caliper straddling a brake disc, at least one brake application device arranged in the caliper on one side of the brake disc for applying the brake, and at least one or more adjusting devices for compensating brake pad wear, which has or have at least one electromotive drive.

A pneumatically actuated disc brake of this type is known from International Patent document WO02/14708. The disc brake disclosed in that document has a caliper which straddles a brake disc. It also has an application device arranged in the caliper on one side of the brake disc. This application device, in particular, has a rotary lever. For the compensation of brake pad wear, two electromotively actuated adjusting devices, respectively, are provided on each side of the brake disc. One electric motor, respectively, on each side of the brake disc, as an electric-motor drive, jointly drives the two adjusting devices on each side of the brake disc.

Like the caliper of the present invention, the caliper of the above state of the art can be constructed as a fixed, hinged and/or sliding caliper. Mixed forms of these systems are also contemplated, as well as solutions in which the caliper and/or the brake disc can deform by a certain path during applications of the brake.

If the caliper is constructed as a fixed caliper, the brake disc could be constructed as a sliding disc, which disc is displaceable on a wheel hub by the amount of the working stroke of the brake.

In the case of pneumatically actuated disc brakes, the parking and emergency brake function or brake is normally implemented by a spring-loaded cylinder which is combined with the service brake cylinder, to form a constructional unit, the so-called combination cylinder. These systems operate very reliably. Their disadvantage is the large required space, the considerable weight and the high manufacturing costs.

It is therefore being considered to implement the parking brake function wherein the brake is actuated by way of the service brake cylinder, and this braking position is held by a mechanical locking. This locking can take place at the brake cylinder itself, at its actuating plunger, or at an actuating element of the application device of the brake (for example, a brake lever).

It is a disadvantage of these solutions that no gradual braking effect can be achieved. Although the parking brake function per se can be implemented, further demands on the emergency brake function are not met.

On the other hand, developments are taking place to replace the mechanical wear adjusting systems of pneumatically actuated brakes, particularly disc brakes, by electromotively actuated and electronically controlled systems.

Likewise, solution suggestions exist which concern an electromotive actuating mechanism, which acts directly or by way of the service brake cylinder upon the brake application device, particularly a rotary lever thereof.

These solutions have the disadvantage that an additional high-expenditure electronic control is required as a result of the additional electromotive actuating system.

Based on this background, an aspect of the invention is to implement in a cost-effective and constructively simple manner the parking brake and/or emergency brake function (this also includes halt braking functions and the like) on a disc brake which can be pneumatically actuated.

The invention achieves this task by operatively configuring at least one of the electromotively driven adjusting devices to be used as a parking and/or emergency brake.

Accordingly, the at least one electromotively actuated adjusting device is designed such that, in addition to carrying out its adjusting function, it can also be used as a parking and/or emergency brake. As a result, the electromotively actuated or electromechanical wear adjusting system is in an advantageous and cost-effective manner also utilized for the implementation of the parking and/or emergency brake function.

It is only necessary to dimension the electromotive drive (or drives) of the adjusting device(s) such that it also meets the requirements of the parking and/or emergency brake function.

Furthermore, only a control device, such as a control computer, which controls the adjusting devices or their motors, in a supplementary manner also has to be designed for carrying out a suitable controlling of the electromotive adjusting device for implementing the parking and/or emergency brake.

Since the same mechanical elements are used for the adjusting devices as well as for the parking and/or emergency brake function, and functions of the electronic control can be used jointly, the parking and/or emergency brake function can virtually be used as an “addition” to the electromotively actuated adjusting device, which is present anyhow, in an extremely cost-effective manner which nevertheless has a reliable effect.

Thus, an electromotive parking and/or emergency brake (also contemplated with the inclusion of the halt function) is implemented, which requires only very low expenditures with respect to the space, the weight and the manufacturing costs.

In particular, the electromotive drive of at least one of the adjusting devices (or of the at least one adjusting device) is dimensioned such that it can be used as a parking and/or emergency brake. It is possible that a slightly more powerful electric motor will have to be used than when the adjusting device is used only for adjusting brake pad wear per se.

Advantageously, apart from the motors, the other mechanical components of the adjusting device are also dimensioned such that they can be used as a parking and/or emergency brake.

Furthermore, electrical/electronic assemblies of the wear adjusting system also have to be designed for the use of the adjusting devices as a parking and/or emergency brake.

If the adjusting devices are arranged on both sides of the disc brake, only one of them could be used for carrying out the parking and/or emergency brake function. It is particularly advantageous to utilize an adjusting device on the actuation side of the brake for implementing the parking and/or emergency brake function.

Constructively, the driving motor could be accommodated in or at the brake housing or caliper and could engage by way of a coupling gear in the transmission gearing. It is particularly advantageous with respect to space to accommodate the driving motor below the brake housing or caliper.

The invention also provides a method of controlling, in particular, disc brakes according to the invention. Accordingly, the parking and/or emergency brake function is implemented while using, or at least while supplementarily using, the electromotive adjusting device. The electromotive adjusting device implements this function either alone, partially, or at least utilized in some form for or during the implementation of this function.

Preferably, in the case of disc brakes with wear adjustment on both sides of the disc, the second adjusting device not required for engaging the parking and/or emergency brake is also controlled for reducing the release play, thus for reducing the application stroke of the first adjusting device.

For reducing the power demand of the electromotive drive when engaging the parking brake, the pressure in the service brake cylinders could be reduced (preferably to the still required extent).

According to another aspect, for determining the pressure of the service brake cylinders required for temporarily stopping the vehicle, in a simple manner, information from inclination sensors and/or other information present in the electronic braking system is used.

The information preferably comprises changes of the output signal of axle load sensors when driving on graded surfaces and/or stored data of the preceding stopping operation on the graded surface, such as brake pressure or achieved deceleration. By using this information, the best possible controlling is then determined.

For reducing the power demand of the electromotive drive of the adjusting device for implementing the parking and/or emergency brake function, it is contemplated that the brake cylinder pressure is reduced only at individual wheels by way of an electronic control device, for example, for each axle or each wheel and, after the engaging of the parking brake at this wheel or at the wheels of this axle, the brake pressure at these wheels is raised again. In this manner, the parking brake is engaged successively at the different axles or wheels of the vehicle.

It is also expedient to generate an electric desired-value signal in a simple manner for controlling the parking and/or emergency brake in the case of an operating element actuated by the driver or through use of an electronic control device, particularly by way of the signals of gradient and/or force sensors. This desired value is converted in the brake-integrated control to an adjusting path of the adjusting screws of the brake application device, this adjusting path being dimensioned such that a defined spreading-open of the caliper is adjusted, which corresponds to the tension force of the caliper necessary for achieving the defined desired value.

According to another variant, a desired-value definition is obtained from the signal of a pressure sensor for controlling the parking and/or emergency brake in the case of vehicles which are equipped only on one axle, for example, the front axle, with an integrated electromotive parking and/or emergency brake and with a conventional spring brakes on the driving axle. The pressure sensor detects the pressure acting upon the spring brakes. In this case, preferably the conventional hand brake valve is retained as the operating element, and the desired value for the electromotive actuation is generated from the control pressure.

Additional advantageous further developments are described and claimed herein.

### BRIEF DESCRIPTION OF THE DRAWINGS

In the following, the invention will be described in detail by means of embodiments.

FIGS. 1 and 2 are two mutually perpendicular sectional views of a disc brake.

### DETAILED DESCRIPTION OF THE DRAWINGS

The basic construction of the disc brake may correspond to the construction described in international patent document PCT/EP01/09370. However, the electric motor should be dimensioned to be powerful enough that it meets the additional demands on the parking and/or emergency brake function or the like.

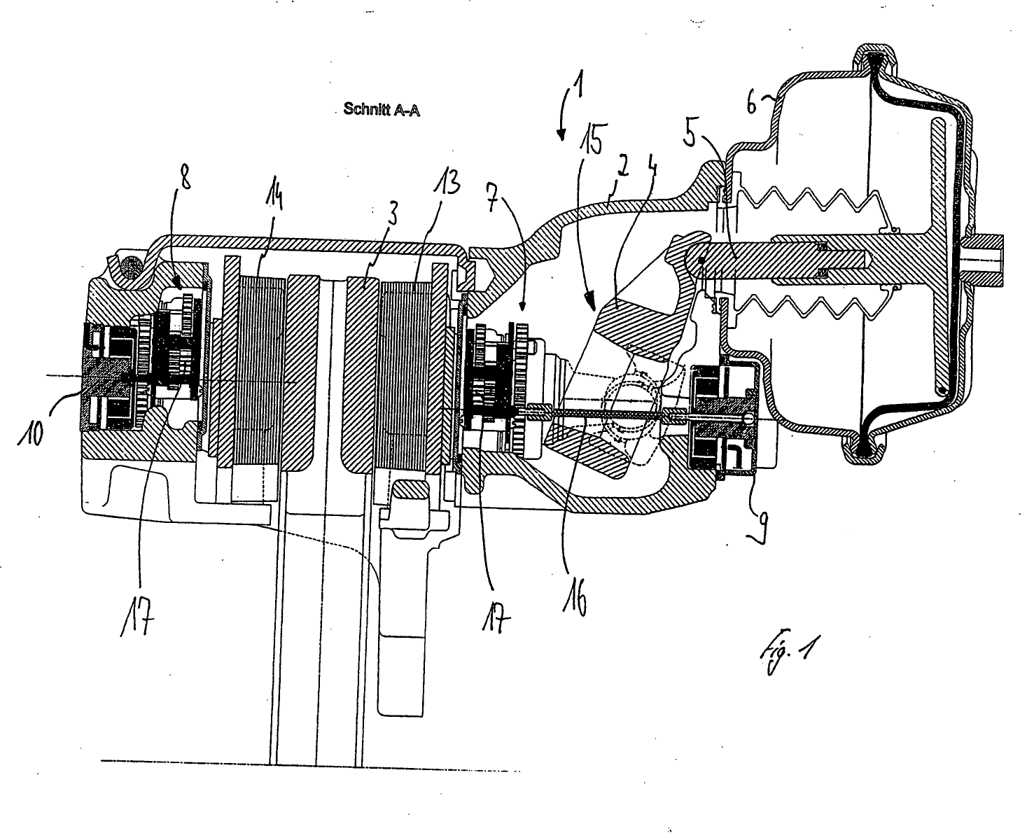

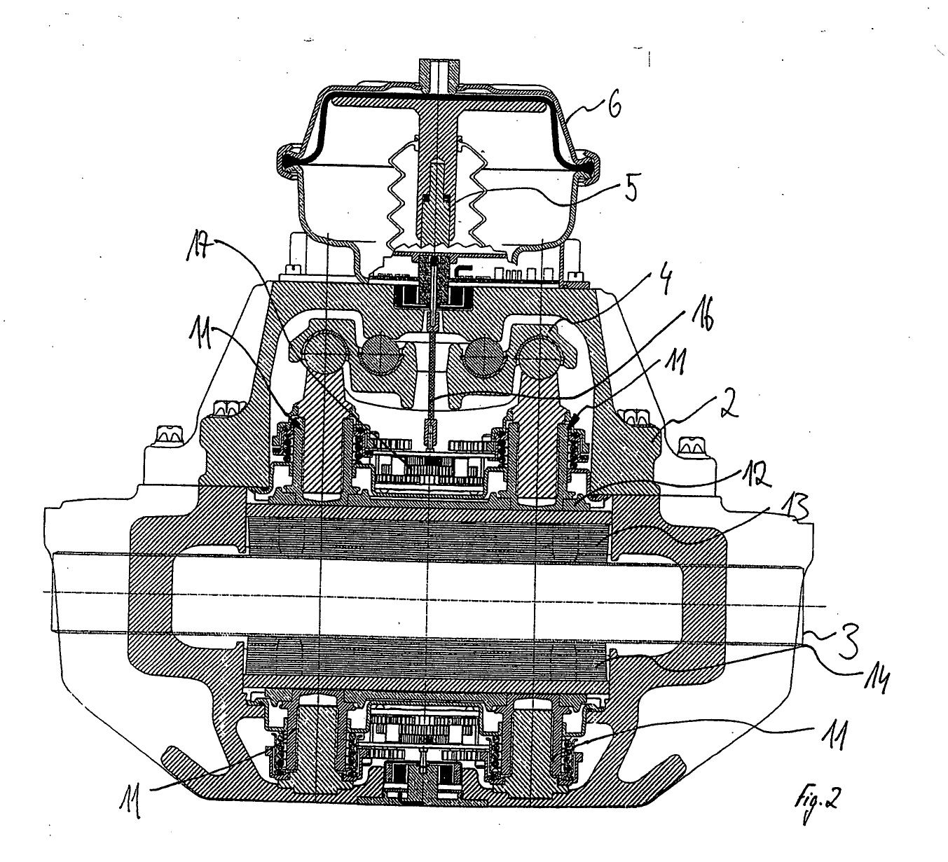

According to FIGS. 1 and 2, the pneumatically actuated disc brake 1 has a caliper 2, which straddles an upper peripheral area of a brake disc 3. In addition, a brake application device 15 is arranged in the caliper 2 at least on one side of the brake disc, particularly with an eccentrically disposed rotary lever 4 to which the actuating plunger 5 of the brake cylinder 6 is applied. As an example, FIG. 1 shows a fixed caliper with an axially movable brake disc 3 (not visible), so that the application device first presses pressure pieces 12 (or a pressure piece plate) with a first brake pad 13 in the direction of the brake disc 3 and then presses these against the additional brake pad 14 on the other side of the brake disc 3.

While the brake application takes place pneumatically, for the adjustment, preferably at least one (here, two) electromotively driven adjusting devices 7 and 8 respectively are provided on each side of the brake disc 3.

Preferably, at least one electric motor 9, 10, for example, an EC motor, respectively, is used as a drive of the two adjusting devices 7, 8 on each side of the brake, respectively. It is also contemplated that, in each case, only one electromotively driven adjusting device 7, 8 is provided on each side of the brake disc or that only a single adjusting device is arranged on one side of the brake disc (for example, in the case of a sliding or hinged caliper concept, for which the invention is also suitable). Here, the electric motors are accommodated on, particularly under the caliper (as an alternative, they can also be mounted in or under it) and engage by way of a coupling gear 16 (here, only on the application side) in the transmission gearing 17 of the adjusting devices.

In practice, the electric motors can or will be slightly larger than in the representation of FIG. 1 in order to also implement the adjusting function because in this case they are not only used for the adjusting function but also for implementing the parking brake, emergency brake, and/or halt brake, etc.

As an alternative, two or more adjusting devices 7, 8 may also be constructed on each side of the brake disc.

According to the invention, the electromotively driven adjusting device 7, 8 is not used for implementing the adjusting function, thus, for compensating the brake pad wear, but also in some manner during the implementation or even completely for the implementation of the parking and emergency braking function.

All elements of the actuating mechanism of the electromotive parking and emergency brake are already present in the electromotive wear adjusting devices and/or on the disc brakes. These are:

1) the electromotive drive 9, 10;

2) the reduction and synchronization gear 17 of the adjusting devices 7, 8; and

3) the adjusting screw system 11.

Furthermore, the following elements also always exist in a separate control unit or in a control unit on or in the disc brake:

1) basic elements of the electronic circuit (power supply unit, EMV (electromagnetic compatibility) protection, etc.);

2) a power control of the electric drive;

3) a position control of the electric drive;

4) a logic circuit of the electronic hardware (microprocessors, etc.);

5) a basic control software (monitoring functions for the electromotive drive and the electronic system), etc.

For implementing the electromotive parking and emergency brake by using the adjusting devices with the electromotive drive, only the dimensioning of the electric motor, the transmission, and the electronic power system have to be adapted to the higher power demand of the parking and emergency brake. The additional software also has to be integrated for the implementation of the parking and/or emergency braking function.

By way of an electric line, the brake is supplied with voltage and/or data. In particular, it is connected to an electronic control unit (EBS control unit or the like), which takes over the control of the disc brakes.

Table of Reference Numbers

disc brake 1
caliper 2
brake disc 3
rotary lever 4
actuating plunger 5
brake cylinder 6
adjusting device 7,8
electric motor 9,10
adjusting screw system 11
pressure pieces 12
brake pad 13
brake pad 14
brake application device 15
coupling gear 16
transmission gearing 17

1-19. (canceled)

20. A pneumatic disc brake for use with a brake disc, comprising:
a caliper which, in use, straddles the brake disc;
at least one brake application device for applying the brake, the brake application device being arranged in the caliper on one side of the brake disc when in use;
at least one wear adjusting device for compensating brake pad wear, the at least one wear adjusting device having at least one electromotive drive and being operatively configured to function as a parking and/or emergency brake;
wherein the electromotive drive includes an electric motor and is operatively dimensioned to drive the wear adjusting device to function as the parking and/or emergency brake.

21. The disc brake according to claim 20, wherein the wear adjusting device includes additional mechanical components appropriately dimensioned for use as the parking and/or emergency brake.

22. The disc brake according to claim 20, wherein the electromotive drive includes electrical/electronic components operatively designed for the wear adjusting device to function as the parking and/or emergency brake.

23. The disc brake according to claim 20, wherein at least one wear adjusting device is arranged on each side of the brake disc.

24. The disc brake according to claim 23, wherein at least two wear adjusting devices are arranged on each side of the brake disc.

25. The disc brake according to claim 23, wherein only a wear adjusting device on one side of the brake disc is operatively configured to function as the parking and/or emergency brake.

26. The disc brake according to claim 20, wherein the at least one electromotively driven wear adjusting device is arranged on an actuation side of the disc brake for implementing the parking and/or emergency brake function.

27. The disc brake according to claim 20, wherein the electric motor is accommodated in, on, or under the caliper; and
wherein the electric motor engages a transmission gearing of the wear adjusting device via a coupling gear.

28. The disc brake according to claim 20, further comprising:
a control unit having a control program, said control program having program code segments that implement the parking and/or emergency brake function by way of the wear adjusting device.

29. A method of controlling a pneumatically actuated disc brake, the method comprising the acts of:
signaling the use of a parking and/or emergency brake function for the disc brake; and
using an electromotive wear adjusting device of the disc brake to implement the parking and/or emergency brake function.

30. The method according to claim 29, wherein when the parking brake function is implemented, a pressure in a service brake cylinder for the disc brake is at least temporarily reduced.

31. The method according to claim 30, wherein for performing the signaling act, the method further comprises the acts of:
obtaining information from gradient sensors and/or other information present in an electronic braking system of the vehicle; and
determining a pressure of service brake cylinders required for temporarily stopping the vehicle.

32. The method according to claim 31, wherein the information includes changes of an output signal of axle load sensors when driving on gradients and/or stored data of a preceding stopping operation on a gradient.

33. The method according to claim 32, wherein the stored data includes one of brake pressure and achieved deceleration of the vehicle.

34. The method according to claim 29, wherein for reducing a power demand of the electromotive adjusting device to implement the parking and/or emergency brake function, a brake cylinder pressure is reduced only at individual wheels, and further wherein after engaging the parking brake at said wheels, the brake cylinder pressure is raised again such that the parking brake is engaged successively at different axles or wheels of the vehicle.

35. The method according to claim 29, wherein for controlling the parking and/or emergency brake function, an electric desired-value signal is generated via one of an operating element operable by a driver, and an electronic control unit via gradient and/or force sensor signals; and
wherein the electric desired-value signal is converted in a brake-integrated control to an adjusting path of adjusting screws of the wear adjusting device, said adjusting path being dimensioned such that a defined spreading-open of the caliper is adjusted corresponding to a tension force of the caliper necessary to achieve the defined desired-value.

36. The method according to claim 29, wherein a desired-value definition is obtained from a signal of a pressure sensor for controlling the parking and/or emergency brake function in the case of vehicles equipped only on one axle with an integrated electromotive parking and/or emergency brake and with conventional spring brakes on a driving axle, which pressure sensor detects the pressure acting upon the spring brakes.

37. The method according to claim 29, wherein, in the case of a disc brake with a wear adjustment device on both sides of the brake disc, the parking and/or emergency brake function is generated only on one side of the brake.

38. The method according to claim 29, wherein, in the case of a disc brake with a wear adjustment device on both sides of the disc, a second adjusting device not required when engaging the parking and/or emergency brake is controlled for reducing a release play and for reducing an application stroke of the first wear adjusting device.

39. A parking brake for a vehicle equipped with a pneumatic disc service brake, comprising:
at least one electromotively driven brake pad wear adjusting device of the pneumatic disc service brake;
an electromotive drive including an electric motor for the brake pad wear adjusting device; and
wherein the electromotive drive is operatively dimensioned to control the service brake as the parking brake.
